(19) United States
(12) Patent Application Publication
(10) Pub. No.: US 2012/0282020 A1
(43) Pub. Date: Nov. 8, 2012

(54) Device for Coupling a Drive Shaft of an Auxiliary Unit of a Commercial Vehicle Having a Gear Drive and Method for Producing Said Device

(75) Inventor: Gilles HEBRARD, Caen (FR)

(73) Assignee: KNORR-BREMSE Systeme fuer Nutzfahrzeuge GmbH, Muenchen (DE)

(21) Appl. No.: 13/469,711

(22) Filed: May 11, 2012

Related U.S. Application Data
(63) Continuation of application No. PCT/EP2010/067094, filed on Nov. 9, 2010.

(30) Foreign Application Priority Data
Nov. 11, 2009 (DE) 10 2009 052 791.5

(51) Int. Cl. F16D 1/116; B23P 17/00

(52) U.S. Cl. 403/316; 29/893.1

(57) ABSTRACT

A device is provided for coupling a shaft for driving an auxiliary unit of a commercial vehicle, having a gear drive with an output gear. The shaft can be fixed in an axial direction parallel to a rotary axis of the shaft by way of a retaining ring. Grooves associated with the retaining ring are disposed on the output gear and on the shaft. A method is also provided for producing the coupling device.

### CROSS-REFERENCE TO RELATED APPLICATIONS

This application is a continuation of PCT International Application No. PCT/EP2010/067094, filed Nov. 9, 2010, which claims priority under 35 U.S.C. §119 from German Patent Application No. DE 10 2009 052 791.5, filed Nov. 11, 2009, the entire disclosures of which are herein expressly incorporated by reference.

### BACKGROUND AND SUMMARY OF THE INVENTION

The invention relates to a device for coupling a shaft for driving an auxiliary unit of a commercial vehicle, having a gear drive which includes an output gear, wherein the shaft can be fixed in an axial direction parallel to an axis of rotation of the shaft by way of a retaining ring.

The invention further relates to a method for producing a device for coupling a shaft for driving an auxiliary unit of a commercial vehicle, having a gear drive which includes an output gear, wherein the shaft can be fixed in an axial direction parallel to an axis of rotation of the shaft by way of a retaining ring.

Connected to the power unit of a vehicle, in particular a commercial vehicle, meanwhile are numerous other auxiliary units, which have to be driven by the power unit and the operation of which is necessary for the functionality of the vehicle. Owing to the limited space in the immediate surroundings of the power unit, ever more complex mechanisms are needed here in order to transmit the drive forces provided by the power unit to the individual auxiliary units. For this purpose use is made, in particular, of gear drives, and sometimes multiple auxiliary units are driven in succession on the principle of a series connection. The order of auxiliary units connected for driving in series may ensue, for example, from the drive energy needed to drive an auxiliary unit, auxiliary units which need a greater drive power usually being arranged closer to the power unit of the vehicle. For example, a pneumatic compressor intended for supplying a compressed air-operated brake system of a commercial vehicle is driven directly by a gear drive of the power unit, whilst a power steering pump, for example, may be driven by the power unit indirectly via an extension of the shaft of the pneumatic compressor.

In order to save energy in the operation of the vehicle, it is advantageous, where possible, to operate energy-consuming auxiliary units only intermittently. A pneumatic compressor, in particular, can be temporarily taken out of operation, provided that a quantity of compressed air sufficient for operation of the brake system is stored within the vehicle. One known method used for this purpose is to provide a clutch between the power unit and the pneumatic compressor, in order to temporarily shut down the pneumatic compressor. It must be ensured here that the auxiliary unit driven via the pneumatic compressor, for example the power steering pump, is not shut down via the clutch together with the pneumatic compressor. This can be achieved, for example, via a correspondingly designed mechanical auxiliary drive, which takes off a corresponding torque upstream of the clutch and to which the power steering pump, for example, can be connected.

FIG. 1 shows a pneumatic compressor having a connection flange for an auxiliary unit on the output side. The pneumatic compressor 30 represented has a gear drive, which is arranged inside a housing 32 and to which a further auxiliary unit, for example a power steering pump, can be coupled via the connection flange 34. The auxiliary unit (not shown) can be subsequently fitted between the connection flange 34 and a cylinder head 40 of the pneumatic compressor 30 after fitting the pneumatic compressor 30 to the power unit of the vehicle. In order to prevent a shaft, to which the auxiliary unit (not shown) is connected, from falling out of the gear drive, pending fitting of the auxiliary unit, a corresponding captive locking fastener must be provided.

FIG. 2 shows a gear drive with an associated shaft according to the state of the art. The gear drive 16 represented in FIG. 2 is arranged on the right-hand side inside the housing 32 represented in FIG. 1. Drive energy in the form of torque is introduced into the gear drive 16 via a drive shaft 36 and transmitted to a driving gear 38, which may be embodied as a gear wheel. The driving gear 38 is coupled with an output gear 14, which may likewise be embodied as a gear wheel and transmits the drive force received to a shaft 12, to which the auxiliary unit (not shown) can be connected. The shaft 12 is supported so that it can rotate about an axis of rotation 20 and, when fitted in an axial direction 18, is pushed into the gear drive 16. In order to secure the shaft 12 captively whilst the auxiliary unit has not yet been fitted, that is to say particularly during transport, a retaining ring 22 is provided, which is fitted in a groove 24 on the housing 32, and after fitting of the shaft 12 fixes the latter in the axial direction 18 with the aid of a groove 26, which is arranged on the shaft 12 itself. A particular disadvantage here is the additional overall length of the housing 32 and the shaft 12 needed for siting the retaining ring and the grooves 24, 26.

The object of the present invention, therefore, is to develop a coupling device such that it is possible to reduce the overall length in an axial direction.

This and other objects are achieved by a device for coupling a shaft for driving an auxiliary unit of a commercial vehicle having a gear drive which includes an output gear, wherein the shaft can be fixed in an axial direction parallel to an axis of rotation of the shaft by way of a retaining ring. Grooves assigned to the retaining ring are arranged on the output gear and on the shaft.

According to the invention, grooves, assigned to the retaining ring, are arranged on the output gear and on the shaft. In this way the groove hitherto needed for fitting the retaining ring on the housing can be dispensed with, since the retaining ring can be fitted directly on the output gear. The overall length of the entire device can therefore be reduced in an axial direction by the width no longer needed.

At the same time the grooves may advantageously run between teeth provided on the shaft and on the output gear. When fitting, therefore, the toothing between the shaft and the output gear can first be brought together without simultaneously having to overcome the captive locking fastener in the axial direction.

Furthermore, the grooves may at least partially cut the teeth provided on the shaft and on the output gear. Since the groove for receiving the retaining ring partially cuts the teeth provided on the shaft and on the output gear, the production process is simplified, since the teeth lying on both sides of the grooves can be produced together, before the teeth are divided in an axial direction by the making of the grooves.

The auxiliary unit may furthermore be a power steering pump.

In particular, tooth edges of the teeth of the output gear, which expand the spring ring during fitting, may be chamfered. Chamfering of the tooth edges firstly facilitates the fitting of the shaft and secondly reduces markedly the likelihood of damage to the shaft during fitting.

The method for producing a device for coupling a shaft comprises the following steps: producing a first groove for partially receiving the retaining ring on the output gear; producing a second groove assigned to the first groove for partially receiving the retaining ring on the shaft; and fitting the retaining ring in the first groove.

Here, the first groove and the second groove can preferably be produced between teeth arranged on the shaft and on the output gear respectively.

Furthermore, teeth arranged on the shaft and on the output gear may be at least partially cut during the production of the first groove and the second groove.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of a pneumatic compressor having a connection flange for an auxiliary unit on the output side;

FIG. 2 illustrates a gear drive with associated shaft according to the state of the art;

FIG. 3 shows a coupling device according to an embodiment of the invention in the uncoupled state; and

FIG. 4 shows a coupling device according to an embodiment of the invention in the coupled state.

### DETAILED DESCRIPTION OF THE DRAWINGS

In the following drawings the same reference numerals denote the same or similar parts.

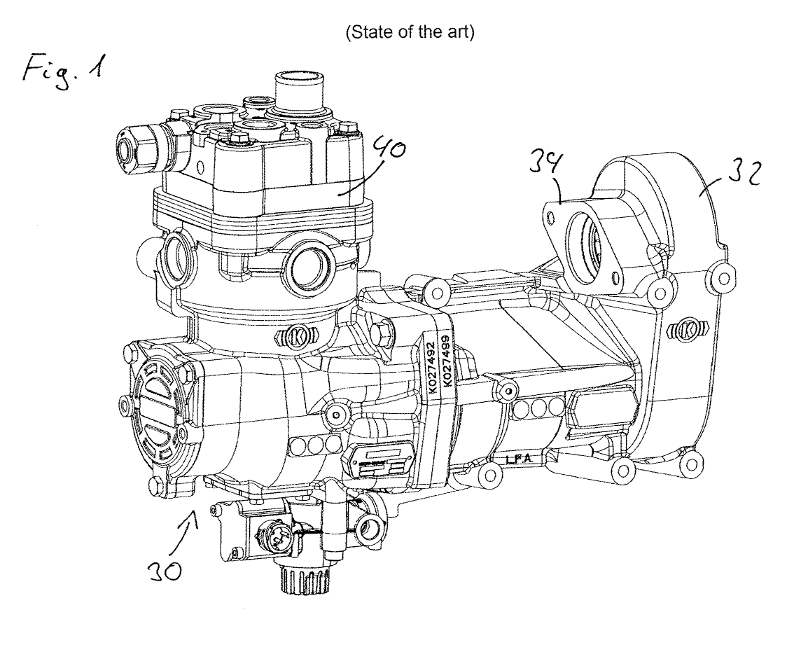

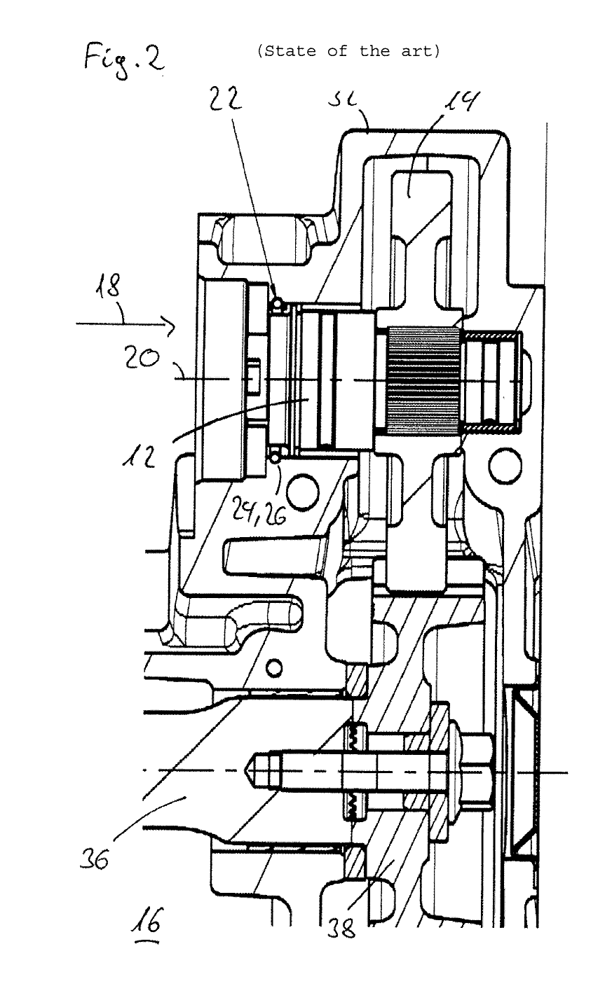

FIG. 1 shows a pneumatic compressor having a connection flange for an auxiliary unit on the output side, and FIG. 2 shows a gear drive with associated shaft according to the state of the art. FIGS. 1 and 2 have already been described.

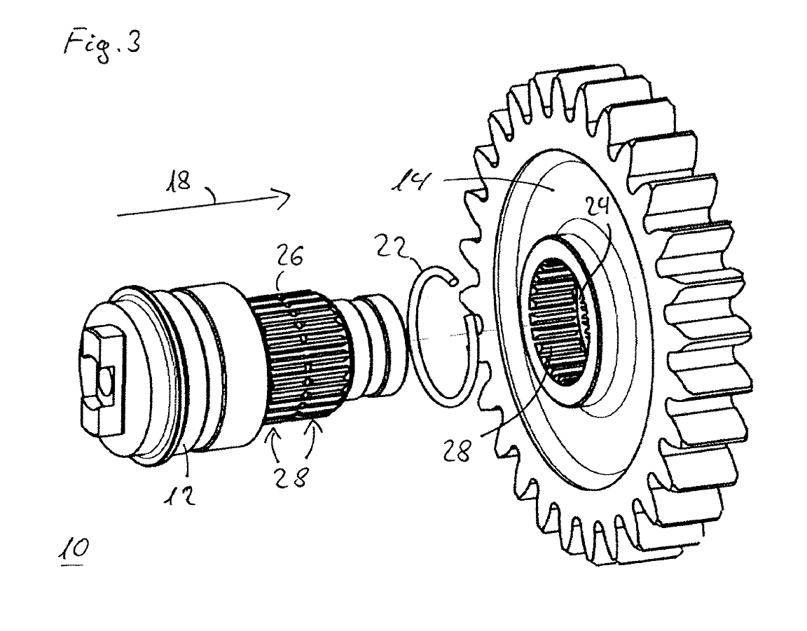

FIG. 3 shows a preferred embodiment of a coupling device according to the invention in the uncoupled state. The shaft 12, the output gear 14 and the retaining ring 22 are shown in an exploded view. The parts shown are joined together in the axial direction 18, which corresponds to the axis of rotation of the shaft 12. This is done by first bending the retaining ring 22 together and placing it over the inner teeth 28 of the output gear 14 in a groove 24. The shaft 12 is then pushed in an axial direction 18 into the output gear 14, the teeth 28 on the shaft 12, together with the inner teeth 28 of the output gear 14, forming a gearing system. As soon as the teeth 28 on the shaft 12 coincide with the retaining ring 22 placed in the groove 24, the ring is expanded in a radial direction, the tooth flanks of the teeth 28 facing the retaining ring 22 possibly being chamfered, in order to avoid peak forces and chipping. As the shaft 12 and the output gear 14 are pushed further together in an axial direction 18, the retaining ring 22 finally reaches a groove 26, which is arranged between the teeth 28 on the shaft 12.

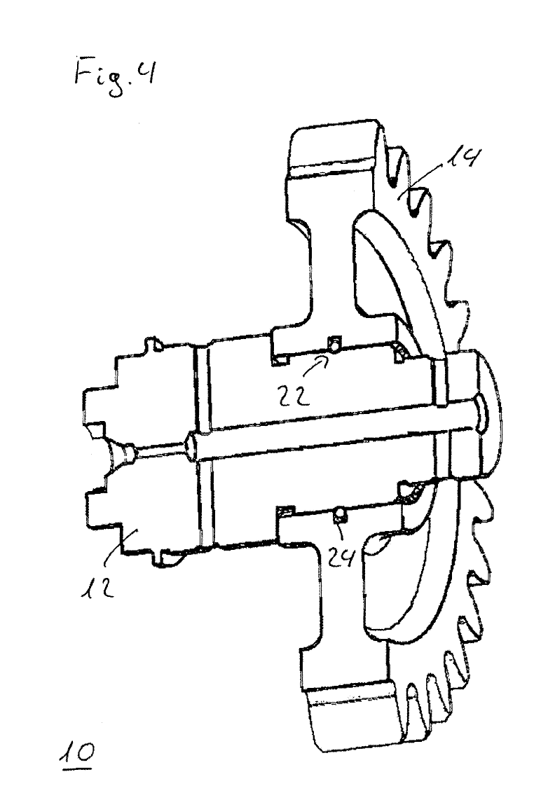

FIG. 4 shows the coupling device in the coupled state in a cross-sectioned view. The coupling device 10 known from FIG. 3 is shown in the coupled state. The retaining ring 22 rests simultaneously in the grooves 24, 26, the groove 26 not being visible on account of the tooth profile on the shaft 12.

The arrangement of the groove 24 on the output gear 14 need not be symmetrical with the longitudinal extent of the output gear 14 in the axial direction 18. In particular, it is also feasible to provide the groove 24 at the edge of the inner teeth 28.

The features of the invention disclosed in the preceding description, in the drawings and in the claims may be essential for the realization of the invention both individually and in any combination.

### LIST OF REFERENCE NUMERALS

10 device
12 shaft
14 output gear
16 gear drive
18 axial direction
20 axis of rotation
22 retaining ring
24 groove
26 groove
28 tooth
30 pneumatic compressor
32 housing
34 connection flange
36 drive shaft
38 driving gear
40 cylinder head

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A device for coupling a shaft for driving an auxiliary unit of a commercial vehicle, the device comprising:
a gear drive including an output gear;
a retaining ring operatively configured to fix the shaft in an axial direction parallel to an axis of rotation of the shaft;
a groove arranged, respectively, on each of the output gear and the shaft, said grooves being assigned to the retaining ring.

2. The device according to claim 1, wherein the grooves are arranged to extend between teeth provided on the shaft and the output gear.

3. The device according to claim 2, wherein the grooves at least partially cut into the teeth provided on the shaft and the output gear.

4. The device according to claim 1, wherein the auxiliary unit is a power steering pump.

5. The device according to claim 2, wherein edges of the teeth of the output gear are chamfered, said chamfered edges facilitating expansion of the retaining ring.

6. A method for making a coupling device for coupling a shaft for driving an auxiliary unit of a commercial vehicle, the coupling device having a gear drive which includes an output gear, and the shaft being fixable in an axial direction parallel to an axis of rotation of the shaft via a retaining ring, the method comprising the acts of:
forming a first groove on the output gear for partially receiving the retaining ring;
forming a second groove, assigned to said first groove, on the shaft for partially receiving the retaining ring; and
fitting the retaining ring in the first groove.

7. The method according to claim 6, wherein the first and the second grooves are produced between teeth arranged on the shaft and on the output gear, respectively.

8. The method according to claim 7, wherein the teeth on the shaft and on the output gear are at least partially cut into during the acts of producing the first groove and the second groove.

9. The method according to claim 8, wherein the tooth edges of the teeth of the output gear are chamfered.
